(19) United States
(12) Patent Application Publication
(10) Pub. No.: US 2004/0124998 A1
(43) Pub. Date: Jul. 1, 2004

(54) Aural/visual interactive aircraft communications module, system and methods

(76) Inventor: Stephen G. Dame, Everett, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/734,434

(22) Filed: Dec. 11, 2003

Related U.S. Application Data
(63) Continuation of application No. 10/163,389, filed on Jun. 4, 2002.
(60) Provisional application No. 60/303,363, filed on Jul. 6, 2001.

(51) Int. Cl. G08B 21/00

(52) U.S. Cl. 340/945

(57) ABSTRACT

The invention provides a Controller-Pilot Data Link Communication (CPDLC) module that can be operatively connected to a cockpit audio system to aurally provide a pilot messages the module receives from ground control and to allow the pilot to operate the module with spoken commands. The module includes an enunciator circuit for playing out a string of digital audio data associated with a message and a voice recognition component for recognizing spoken commands and performing tasks in response to the commands. Thus, the pilot can use CPDLC protocols to exchange information with ground control yet communicate with ground control by listening and talking as if he was communicating with a voice radio. The module can also visually present messages and other information and receive input from programmable buttons and a knob. The functions of the buttons and knob change as the operational state of the module changes. For example, when the module displays current messages, pushing a button causes the module to perform a task, and when the module displays possible responses to a message, pushing the same button causes the module to perform a different task. Furthermore, the module can include, visually present and/or aurally provide a checklist of tasks to be completed when a message associated with the checklist is received or sent by the module.

### CROSS-REFERENCE TO RELATED APPLICATIONS

This application claims priority from commonly owned U.S. Provisional Patent Application 60/303,363, titled Interactive Aural/Visual CPDLC system, presently pending, which is hereby incorporated by reference in its entirety.

### BACKGROUND

The current international air traffic control system depends significantly on radio voice communications between pilots and air traffic controllers to manage airspace flight control information that is critical to expeditious and safe flight operation. These communications support coordination of flight information such as aircraft movement, aircraft vertical and lateral separation, radio frequency changes, operation clearances and aviation weather services.

Radio voice communications presents several problems. First, the voice communication between air traffic controllers and pilots operates essentially as a conference call, with the controller and multiple aircraft pilots sharing the same radio channel. This has two consequences. First, pilots frequently simultaneously key their radio transmitters on the same frequency and accidentally “step on” the communication of other pilots or controllers. As repeated attempts to communicate are made, time is wasted. Second, to establish communication, a radio channel is reserved for a pilot's and controller's use even when neither is sending the other a message. Thus, there is a saturation point where an air traffic controller cannot handle any additional voice radio communications. At this point, no additional aircraft can be handled within the controller's assigned airspace. Another problem with radio voice communications is that voice based clearances and readbacks are frequently not clearly understood due to limited radio bandwidth, radio channel noise, heavy foreign accents and general misunderstanding or misinterpretation of the information.

To help resolve these problems, the United States Federal Aviation Administration unveiled its cooperative ten-year Operational Evolution Plan to expand capacity and manage delays in the air transportation system by reducing radio voice communications between pilots and controllers. To accomplish this, the plan includes the deployment of a data link system or more specifically a Controller-Pilot Data Link Communications (CPDLC) system. The CPDLC system is designed to replace voice based clearances and readbacks between the pilot and air traffic controller by exchanging messages in an unambiguous digital format between aircraft and ground control computers. When either party's computer receives a message, the computer will display the text of the message for the pilot or air traffic controller to read and acknowledge. Thus, the pilots and controllers can exchange efficient and precise clearance information without the problems associated with using radio voice communications. And radio voice communications can be used in emergencies or other situations, for example as a backup to the CPDLC system.

To exchange information between the pilot and ground control computers, the CPDLC system uses message sets that include clearance and response messages and a numeric code associated with each message that is transmitted between the pilot and controller computer. FIG. 1 shows a table of a current message set 10. As shown in FIG. 1, the messages 12 can be divided into two groups, uplink 14 and downlink 16. Uplink messages are sent from the ground controller to the pilot, while downlink messages are sent from the pilot to the ground controller. Some uplink and downlink messages require the sender to include additional information in the message, such as altitude, speed or position to complete the message. For example, the uplink message “CLIMB TO” requires an altitude value for the message to make any sense to the pilot. The numeric codes are digitized and exchanged between the aircraft and ground control computers. Once a computer receives a numeric code 18, the computer converts the code 18 into text and displays the text. Thus, when the aircraft computer receives a digital data message from the ground control computer, the aircraft computer displays the uplink message associated with the numeric code and vice-versa. In this manner, the messages can be efficiently sent from ground to air or air to ground via a digital stream of information that is encoded into a VHF, HF or satellite based transmission.

An aircraft's CPDLC computer is usually incorporated into the aircraft's flight management computer system. This, however, presents two problems for the pilot or other person, such as a co-pilot, using the CPDLC system.

First, the pilot or other user can be inundated with information the flight management computer system provides. This can cause the pilot to waste time isolating and focusing on the information he/she needs for the task at hand. When the flight requires the pilot to perform many tasks within a short period of time, such as approaching a runway and landing, the time wasted by the pilot can force the pilot to inadvertently miss valuable information or ignore valuable information to keep abreast of the required tasks.

Second, the pilot or other user cannot receive messages aurally from the aircraft's CPDLC computer or control the aircraft's CPDLC computer using spoken commands because the flight management computer system is typically not connected to the cockpit audio system. Receiving messages aurally allows the pilot or other user to focus their gaze outside the aircraft or onto another instrument in the cockpit. Spoken commands allow the pilot to use his hands for other tasks in the flight while communicating with the ground controller. For example, the pilot may be required to keep one hand on the stick and the other hand on the throttle while the co-pilot operates the flight management computer system.

Thus, there is a need to for an interactive aural and visual CPDLC computer that uses new emerging CPDLC protocols to facilitate and enhance communications between the pilot or other user in the cockpit of an aircraft and the ground controller.

### BRIEF DESCRIPTION OF THE FIGURES

FIG. 1 is a table of messages and associated numeric codes included in a message set that is used by a CPDLC system.

FIGS. 2A and 2B are front views of a CPDLC module in a normal operational state according to an embodiment of the invention.

FIGS. 3A and 3B are front views of the CPDLC module in FIGS. 2A and 2B in a response operational state according to an embodiment of the invention.

FIG. 3C is a front view of the CPDLC module in FIGS. 3A and 3B returned to the normal operational state after a response has been selected and sent, according to an embodiment of the invention.

FIGS. 4A and 4B are front views of the CPDLC module in FIGS. 2A and 2B in a downlink operational state according to an embodiment of the invention.

FIG. 5 is a block diagram of a processing system incorporated in the CPLDC module in FIGS. 2A-4B according to an embodiment of the invention.

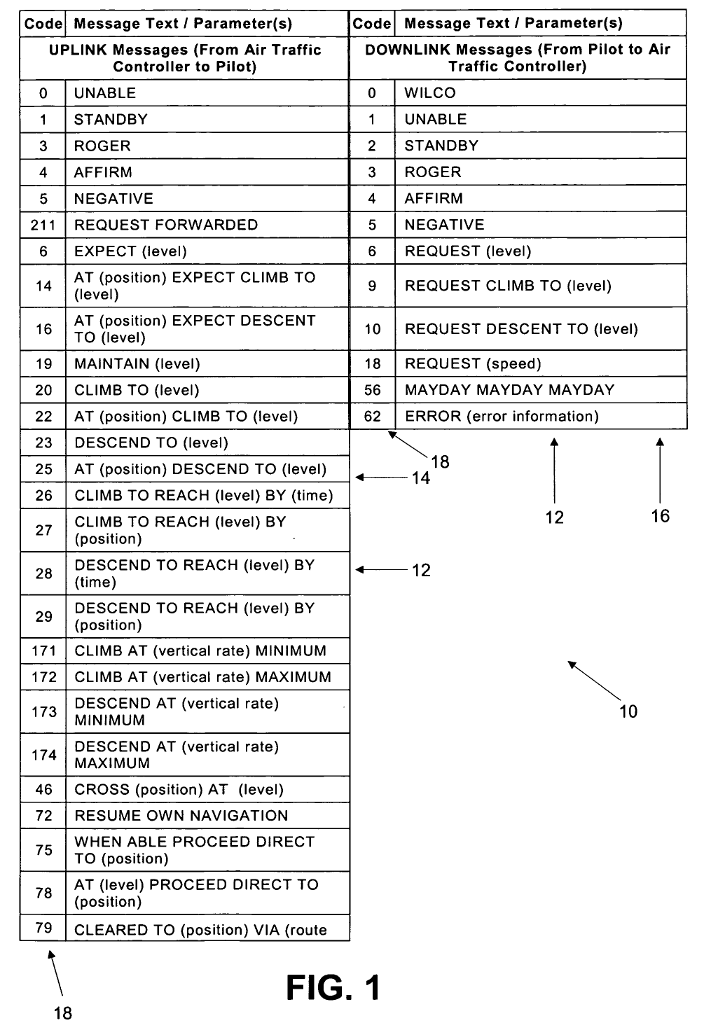

### SUMMARY

In one aspect of the present invention, an aircraft CPDLC module comprises a multi-line display for visually presenting a list of messages, one or more programmable buttons and knob for inputing data into the CPDLC. The display can present the list of messages such that the list can be scrolled from the top down or bottom up to display any portion of the list. When the messages are scrolled from the top down, the most recent message is displayed at the top of the display, and when the messages are scrolled from the bottom up, the most recent message is displayed at the bottom of the display. The display can also present other types of information. For example, the display can visually present an indicator included in the message that indicates whether the message displayed is an uplink or downlink message and an arrow that indicates the scrolling direction. The display can also visually present a response tag that identifies the response selected by the pilot in response to an uplink message. The response tag can be a letter of the alphabet corresponding to the selected response and can be displayed after the pilot sends the response. The display can also present identifiers for one or more possible responses appropriate to an uplink message when an uplink message is received. The display can also present labels each corresponding to a programmable button to indicate the function of the button.

The one or more buttons and knob are manipulated to input data into the module. The one or more buttons can be pushed while the knob can be pushed and rotated. When the knob is pushed for a duration longer than a predetermined duration (which can be adjustable), confirmation of a selected message or task can be made. Furthermore, depending on the operational state of the module, pushing a button or the knob for a duration less than the predetermined duration or rotating the knob can input different data into the module. For example, when the display presents a portion of a list of messages that includes the most recent message, pushing a button can cause the module to display a different portion of the list of messages, and when the display presents a list of possible responses to an uplink message, pushing the same button can cause the module to select a response. As another example, when the display presents a list of possible responses to an uplink message, pushing the knob for a duration less than the predetermined duration can cause the module to advance by one possible message through the displayed list, and when the display presents a portion of a list of messages, pushing the knob for a duration less than the predetermined duration can cause the module to scroll to and display the most recent uplink message. As another example, when the display presents a portion of a list of messages, rotating the knob can cause the module to scroll through the list and display a different portion of the list of messages, and when the display presents a downlink message that requires a data value, such as 33,000 ft, rotating the knob can cause the module to scroll through and display different data values.

In another aspect of the invention, an aircraft CPDLC module comprises a memory containing a plurality of digital audio data strings and a digital audio enunciator circuit that plays out a string of digital audio data from the memory corresponding to a CPDLC message selected from a plurality CPDLC messages. Thus, the pilot can receive messages from ground control without having to read the messages on the display of the CPDLC module. This allows the pilot to focus his eyes on other sources of information in the cockpit, which can be necessary during some portions of a flight, such as approaching and landing. Each digital audio data string corresponds to a message, event or task, the module encounters and can include digital audio voice data that is pre-recorded or synthesized or can include digital audio sound data, such as a tone or chime. For example, a digital audio voice data string can correspond to a message received or sent by the module, and when the module receives or sends the message, the module can play the digital audio data string through the cockpit audio system. As another example, a digital audio voice data string can correspond to a request to confirm a response to an uplink message, and when the pilot selects a response, the module can play the digital audio data string through the cockpit audio system before sending the response. As another example, a digital audio sound data string can correspond to the event of receiving a message, and when a message is received the module plays the digital audio data string to notify the pilot that a message has arrived.

In another aspect of the invention, an aircraft CPDLC module comprises an audio input that receives spoken audio voice data and a speech recognition component that identifies commands in the spoken audio voice data. Thus, the pilot can operate the module with spoken commands and does not have to use the buttons or knob. This allows the pilot to use his hands for other tasks, which can be necessary during some portions of a flight, such as approaching and landing. The speech recognition component can receive spoken audio voice data from the pilot through the cockpit audio system. To facilitate identifying a spoken command, the speech recognition component identifies possible commands with an operation state of the module in which the command is likely to be spoken. Furthermore, the speech recognition component can notify the pilot whether the component has identified the spoken command or not by playing a first aural sound when the command is identified and playing a second aural sound when the command is not identified.

In another aspect of the invention, an aircraft CPDLC module comprises a checklist of tasks that corresponds to an uplink message and a possible response to the uplink message. The checklist is stored in the memory of the module and is associated with an uplink message by a tag included in the message. After the module receives an uplink message that is associated with a checklist and the pilot confirms a response to the uplink message that requires the pilot to perform tasks from a checklist, the module automatically displays a portion of the checklist. Furthermore, the module can scroll through and display other portions of the checklist as the pilot accomplishes the tasks displayed. In addition, the module can also aurally provide the pilot the checklist through the cockpit audio system by enunciating the tasks included in the checklist.

In another aspect of the invention, a method for selecting and confirming a response to an uplink message using a CPDLC module comprises: a) receiving an uplink message requiring a response, b) visually displaying one or more possible responses appropriate to the content of the uplink message, c) receiving from a user a selection of a response from the one or more possible responses displayed and d) receiving from a user a confirmation of the selected response before issuing the response. In addition, The confirmation of the selected response can be performed by pushing a knob for a predetermined duration or longer or speaking the command “confirm”. Furthermore, a user can select a different response before confirming the previously selected response by pushing the knob for a duration less than the predetermined duration to advance from the previously selected response to another response.

### DETAILED DESCRIPTION

All terms used herein, including those specifically described below in this section, are used in accordance with their ordinary meanings unless the context or definition indicates otherwise. Also, unless indicated otherwise, except within the claims, the use of “or” includes “and” and vice-versa. Non-limiting terms are not to be construed as limiting unless expressly stated (for example, “comprising” means “including without limitation” unless expressly stated otherwise).

The present invention provides a CPDLC module that can receive and send messages from ground controllers using CPDLC protocols. The module can stand alone in the cockpit (i.e. the module does not have to be incorporated into other computer systems in the cockpit such as the flight management computer system) to allow the pilot or other user to focus and concentrate on the messages received from the ground controller. If the module is incorporated in the flight management computer system (FMCS), the information displayed by the CPDLC module can be easily lost among other important information displayed by other modules incorporated in the FMCS. The module includes a display for presenting messages and other information appropriate to the messages and operational state of the module, and buttons and knobs that can be manipulated to input data into the CPDLC module. Furthermore, the module can include an enunciator circuit and voice recognition component and can be connected to the cockpit audio system to aurally provide or receive information to or from the pilot or other user. This allows the pilot to hear messages the module receives and to input data into the module by speaking commands. In addition, the CPDLC module can include a checklist to provide the pilot or other user a checklist for a set of tasks appropriate to a received message. For example, when the pilot receives instructions, such as a change in altitude, a checklist can be provided visually and/or aurally to insure the pilot completes all the tasks associated with changing his/her aircraft's altitude.

The messages received and sent by the CPDLC module consist of uplink messages and downlink messages that are stored in the module with the current message or messages presented by the display. Uplink messages are messages received from the ground controller and include messages that require a response from the pilot or other user. Downlink messages are messages sent to the ground controller and include the pilot's or other user's response to an uplink message and request for information or changes in the flight plan. For example, the ground controller might direct the pilot to climb to a higher altitude to which the pilot responds by agreeing, requesting a different altitude or requesting the message be repeated. Or, the pilot may request a weather report of a future destination from the ground controller or the pilot may request a different altitude. Some uplink and downlink messages can also contain data values such as 37,000 feet that complete the message. These data values are input by the sender of the message before sending the message.

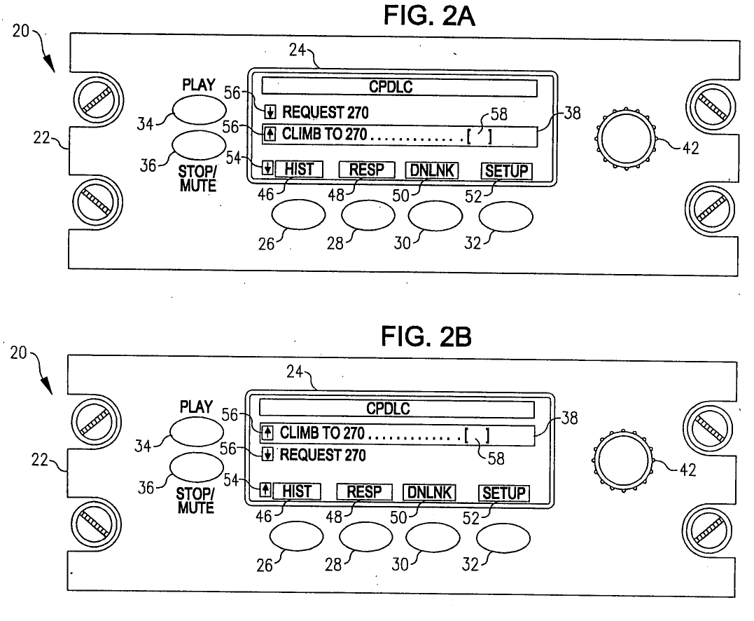

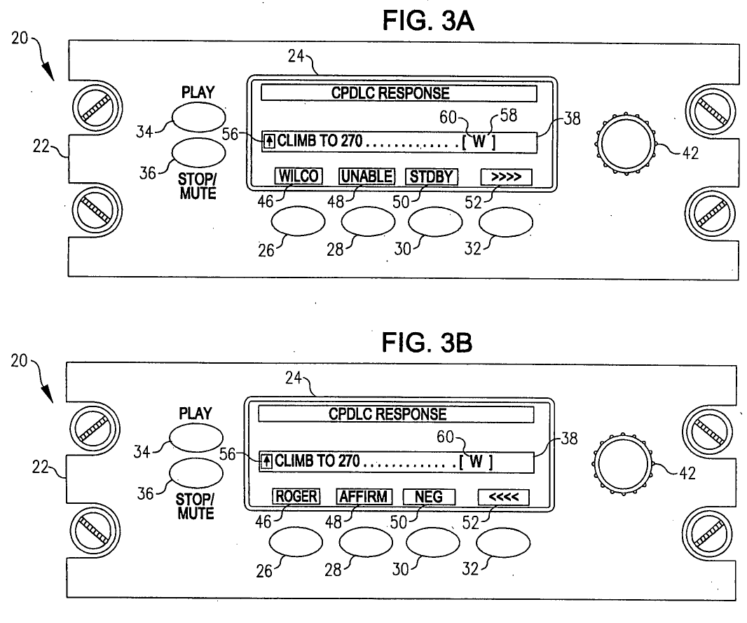

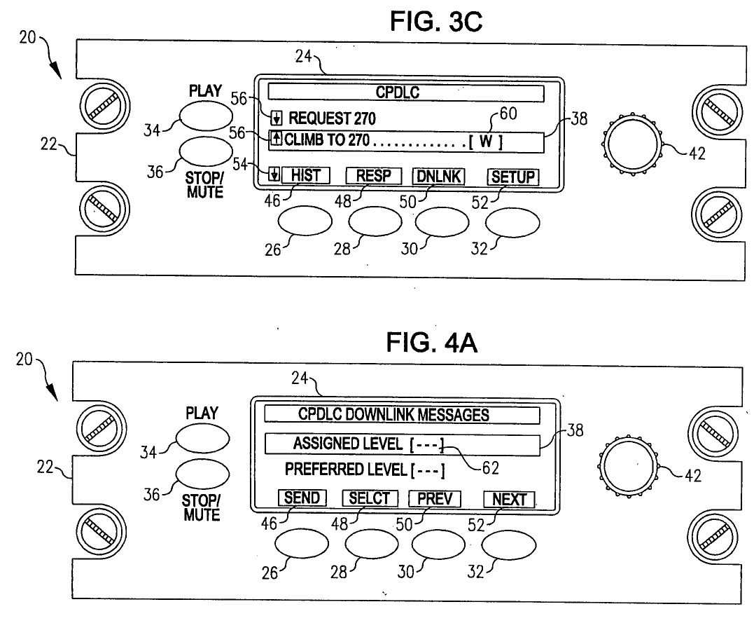

The CPDLC module can exist in several operational states wherein the module displays certain messages and other information. For example, the CPDLC module can exist in a normal state, history state, response state, downlink state, confirmation state and setup state. In the normal state, the display can present the current message or messages upon receiving or sending a message (shown in FIGS. 2A and 2B). When the module receives or sends a message, the module removes the oldest message currently presented and displays the message just received or sent. Thus, the pilot or other user can visually see the most current messages exchanged between the pilot or other user and ground controller. In the history state, the display can present one or more messages contained in the list of messages stored in the module that are not currently displayed. Thus, the pilot or other user can view the history of their conversation with the ground controller. This may be desirable when the pilot or other user wants to retrieve information included in an older message such as a previous course heading. In the response state, the display can present responses to a currently pending uplink message for the pilot or other user to select from (shown in FIGS. 3A-3C). This may be desirable when the pilot or other user is too busy with other tasks to search for the downlink message containing the pilot's desired response. In the downlink state, the display can present a group of downlink messages for the pilot or other user to select from. This may be desirable when the pilot wants to initiate communication with ground control. In the confirmation state, the module waits for the pilot or other user to confirm a selected response or selected data value before sending the response or other downlink message (shown in FIGS. 4A and 4B). In the setup state, the pilot or other user can modify programmable features of the module.

FIGS. 2A and 2B are front views of a CPDLC module 20 in the normal state according to an embodiment of the invention. The module 20 includes a panel 22 that includes a display 24, buttons 26-36 and, a knob 42. The display 24 presents one or more messages grouped by when they were received or sent by the module and other information the pilot or other user may need to operate the module 20. For example, the display can present labels 46-52 that indicate the function of corresponding buttons 26-32. The buttons 26-36 and knob 42 allow the pilot to input data into the module 20 to operate and control the module 20. For example, pushing the button 28 can change the operational state of the module 20 from the normal state to the response state.

In this and certain other embodiments, the display 24 is designed to provide good visibility in bright sunlight conditions over a wide range of operating temperatures. For example, the display can be a conventional vacuum fluorescent, flat panel, color display and include an inverse highlight 38 to indicate a selected message. When the CPDLC module 20 receives a new uplink message or sends a new downlink message that is not a response to an uplink message, the module 20 removes the oldest displayed message from the display 24 and presents the new message. Furthermore, the display 24 can present multiple lines of text. For example, the display 24 can present one or more messages that include two or more lines of text or two or more messages that include a single line of text. When a message has more than one line of text, the text of the message is wrapped to the next line so that the whole message can be displayed.

Still referring to FIGS. 2A and 2B, in this and certain other embodiments, the display 24 can also present a direction arrow 54, an indicator 56 and a response tag area 58. The direction arrow 54 shows the pilot or other user the direction the module 20 scrolls the messages when it receives or sends a new message. Thus, the direction arrow tells the pilot or other user whether the top message—“REQUEST 270” in FIG. 2A—is more recent than the bottom message—“CLIMB 270” in FIG. 2A——or vice versa. As shown in FIG. 2A the bottom message is more recent than the top message. An indicator 56 is associated with each message the module sends or receives and shows the pilot or other user the kind of message displayed. For example, the indicator 56 can be an arrow indicating whether the message presented is an uplink message or a downlink message. As shown in FIG. 2A, the displayed message “REQUEST 270” has an arrow pointing down to indicate this message is a downlink message. By marking each message with an indicator, the pilot can quickly and easily determine whether the message was an uplink or downlink message. This makes it easier for the pilot to quickly find a particular uplink or downlink message when scrolling through all the messages sent and received by the module 20. A response tag area 58 is displayed with uplink messages that require a response from the pilot or other user. As discussed in greater detail in conjunction with FIG. 3C, after the pilot sends a response to an uplink message, the module 20 can display the uplink message with a response tag (not shown) in the response tag area 58 that indicates the response to the uplink message that was sent.

Still referring to FIGS. 2A and 2B in this and certain other embodiments, the display 24 can also present labels 46-52 that correspond with buttons 26-32 respectively and indicate the function of the corresponding buttons 26-32. For example as shown in FIGS. 2A and 2B, the label 46 includes “Hist” to indicate that pushing the button 26 causes the operational state of the module 20 to change to the history state. This makes previous messages received and sent by the module 20 available for display. The label 48 includes “Resp” to indicate that pushing the button causes the operational state of the module 20 to change to the response state. This displays a group of responses to the currently pending uplink message—“CLIMB TO 270”—as shown in FIGS. 3A and 3B. The label 50 includes “DnLnk” to indicate that pushing the button 30 causes the operational state of the module 20 to change to the downlink state. This displays a group of downlink messages as shown in FIGS. 4A and 4B. The label 52 includes “Setup” to indicate that pushing the button 32 causes the operational state of the module 20 to change to the setup state. This allows the pilot or other user to modify programmable features of the module 20. Furthermore, these labels can change to reflect the change in the function of the buttons 26-32 as discussed in more detail below.

Still referring to FIGS. 2A and 2B, in this and certain other embodiments, the buttons 26-36 allow the pilot or other user to input data into the module 20. The buttons 26-32 can be pushed to change the contents of the display 24 and or select a response to a currently pending uplink message. To provide these functions, the buttons 26-32 can be programmed by the pilot or user or automatically programmed by the module 20. Such programming can change the function of the buttons 26-32 according to the operational state of the module 20 or the content of a selected message. Thus, the number of buttons needed to control the CPDLC module 20 can be minimized, and the CPDLC module 20 is easier to use.

For example, as shown in FIGS. 2A and 2B, when the display 24 presents the most recent message or messages received or sent by the module 20 and an uplink message requiring a response is selected, pushing the button 28 will cause the module 20 to display a group of responses appropriate to the uplink message. More specifically, the text of the labels 46-52 will change to display some or all of the appropriate responses (FIGS. 3A and 3B). Furthermore, the function of the buttons 26-32 will also change to correspond to the text of the corresponding labels 46-52. Thus, the pilot or other user can select a response identified by one of the labels 46-52 by pushing the button 26-32 corresponding to the label (FIGS. 3A and 3B).

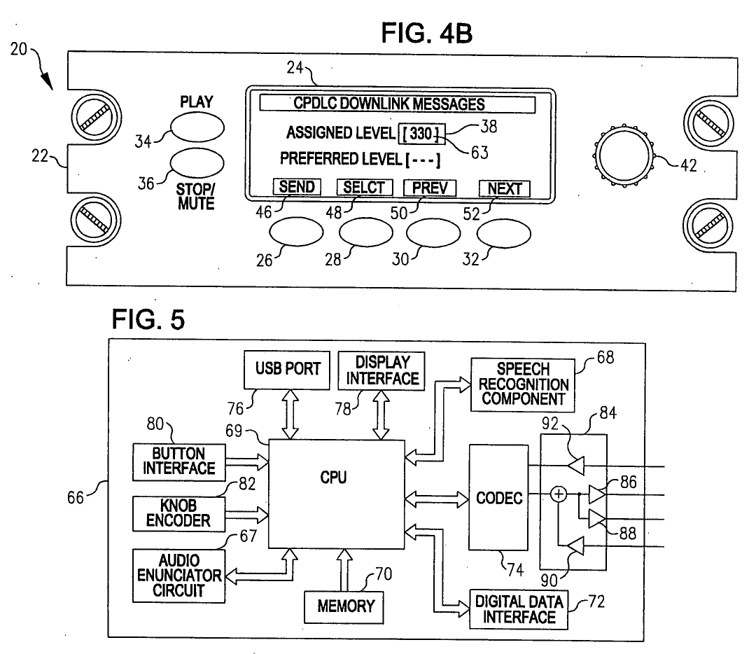

Still referring to FIGS. 2A and 2B, in this and certain other embodiments, pushing the button 26 makes previously sent and received messages available for the pilot or other user to retrieve. Pushing the button 30 causes the module 20 to display downlink messages that are typically not responses to an uplink message, such as a request to change course headings. And, pushing the button 32 allows the pilot or other user to modify programmable features of the module 20. For example the pilot or other user can configure the scroll direction of the display, enable speech recognition (discussed in greater detail in conjunction with FIG. 5), choose a chime or sound to announce the arrival of a message, modify the time constituting the predetermined duration (discussed in greater detail below) or other desired programmable features.

Still referring to FIGS. 2A and 2B, the knob 42 has multiple functions. In this and certain other embodiments, these functions can change according to the operational state of the module 20 or the content of a selected message. For example, after the button 26 is pressed, the pilot or other user can rotate the knob to scroll through the list of previously sent and received messages. Rotating the knob 42 counter-clockwise can allow the pilot to scroll through the list from the more recent to the less recent, and rotating the knob 42 clockwise can allow the pilot or other user to scroll through the list from the less recent to the more recent; or vice versa. Or, after a message requiring data value input is selected, the pilot or other user can rotate the knob to scroll through a list of data values. For example, when a pilot or other use selects the downlink message “REQUEST______”, the pilot can rotate the knob 42 to scroll through a list of altitude values to select and input an altitude into the downlink message.

Still referring to FIGS. 2A and 2B in this and certain other embodiments, the knob 42 can also be pushed to cause the module to perform tasks that differ according to the duration of the push and according to the operational state of the module 20 or the content of a message selected. A specific duration—typically 3 seconds but can be any duration desired—is determined by the pilot or other user and programmed into the module 20. If the knob 42 is pushed for a duration shorter than the predetermined duration the module 20 performs a task according to the operational state of the nodule 20. If a pilot pushes the knob 42 for a duration longer than the predetermined duration the pilot confirms a previously selected downlink message or data value.

Examples of tasks performed by the module 20 when the knob 42 is pushed for less than the predetermined duration include the following. In the history state, after the pilot has rotated the knob 42 to scroll through the list of messages, the pilot can push the knob 42 for less than the predetermined duration to display the most recent pending uplink message and possible responses thereto. Once the module is in the response state, the pilot can then push the knob 42 again for a duration less than the predetermined duration to advance by one response through the possible responses.

Still referring to FIGS. 2A and 2B, in this and certain other embodiments, the buttons 34 and 36 allow the pilot or other user to input additional data into the module 20. For example, pushing the button 34 can cause the module 20 to aurally announce the reception or transmission of a message. The module 20 can announce these in any manner desired. For example, the module 20 can play the message using prerecorded or synthesized digital audio data corresponding to the message as discussed in greater detail in conjunction with FIG. 5. Additionally or alternatively, the module 20 can play sounds such as a tone, chime, or any other desired sound. Pushing the button 36 when the module is playing a message can cause the module 20 to mute only the current message. But, pushing the button 36 when the module is not playing a message can cause the module 20 to not play any subsequently received or sent messages.

FIGS. 3A and 3B are front views of a CPDLC module 20 in the response state according to an embodiment of the invention. FIGS. 3A and 3B illustrate the display 24 after a pilot or other user has selected a pending uplink message and pushed the button 48 (FIGS. 2A and 2B) to display a list of responses to the uplink message. FIG. 3C is a front view of a CPDLC module 20 returned to the normal state after the pilot or other user sends a selected response, according to an embodiment of the invention, and illustrates the display 24 after the pilot or other user sends the selected response.

Referring to FIGS. 3A and 3B in this and certain other embodiments, the display 24 presents the selected pending uplink message and responses thereto that the pilot can select. The responses displayed can be all possible responses to the uplink message or a subset of all the responses divided as desired. For example, the display 24 can present only the responses appropriate to the content of the uplink message. The pending uplink message can include a response tag 60 located in the response tag area 58 that identifies a selected response to the uplink message. The response tag can be any desired graphic associated with a specific response. For example, the response tag 60 can be the first letter of the associated response, such as “W” for “Wilco”.

Still referring to FIGS. 3A and 3B, the selection of a response can be performed by the pilot or other user, or automatically by the module 20. For example, the pilot or other user can select a response by pushing one of the buttons 26-30. Or, the module 20 can automatically select one of the responses when the pilot pushes the button 28 (FIGS. 2A and 2B). After a response is selected the pilot confirms the selection before the module 20 sends the response.

In this and certain other embodiments, the pilot or other user can confirm the response by pushing the knob 42 for a duration longer than the predetermined duration or as discussed in conjunction with FIG. 5 by saying “confirm”. Although confirmation of a selected response is discussed in conjunction with FIGS. 3A and 3B, the pilot or other user can confirm other selected messages, data values, or any other desired input by either method discussed above.

Still referring to FIGS. 3A and 3B, in this and certain other embodiments, before confirming a selected response the pilot or other user can select a different response by pushing one of the other buttons 26-32 or pushing the knob 42 for a duration less than the predetermined duration. Pushing the knob 42 can advance the response selection by one response. For example, if the first selected response was “Wilco”, then pushing the knob 42 for a duration less than the predetermined duration selects the response “Unable”. As shown in FIGS. 3A and 3B, if the number of responses appropriate for an uplink message exceeds the number of buttons 26-32 then, one of the buttons 32 of 26-32 can be used to display additional appropriate responses (FIG. 3B).

Referring to FIG. 3C, in this and certain other embodiments, when the module 20 displays the uplink message in the normal to operational state, the module 20 can display the response tag 60. Furthermore, the module can store the uplink message with the response tag 60. Thus, the pilot or other user can quickly see the response he sent to the uplink message when referring to the uplink message in the future.

FIGS. 4A and 4B are front views of a CPDLC module 20 in the downlink state according to an embodiment of the invention. FIGS. 4A and 4B illustrate the display 24 after a pilot or other user has pushed the button 50 (FIGS. 2A and 2B) to display downlink messages.

Referring to FIGS. 4A and 4B, in this and certain other embodiments, the display 24 presents one or more downlink messages and labels 46-52 that indicate functions of the buttons 26-32 associated thereto. The pilot or other user can push either button 30 or 32 to scroll through the list of available downlink messages. When the pilot or other user finds a message he desires he can push the button 28 to select the message. If the selected message requires a data value 63 to be input to complete the message, the display 24 will present the message with an empty data field 62. To insert the data value 63 into the data field 62, the pilot or other user can rotate the knob 42. Once the desired data value 63 is displayed in the data field 62, the pilot or other user can confirm the selected data value 63, as previously discussed, and then can push the button 26 to send the message.

FIG. 5 is a block diagram of a processing system 66 of a CPDLC module according to an embodiment of the invention. In this and certain other embodiments, the processing system 66 includes a digital audio enunciator circuit 67 for aurally providing information to the pilot or other user and aurally receiving commands from the pilot or other user. In addition, the processing system 66 includes a speech recognition component 68 for identifying commands spoken by the pilot or other user. With the enunciator circuit 67 and speech recognition component 68, the pilot can communicate with ground control by talking and listening—the manner of communication familiar to pilots—and by sending and receiving digital data messages. Thus, the pilot or other user's hands and eyes can be used for other tasks and the volume of communications between the pilot or other user and ground controller can be more efficiently handled.

In this and certain other embodiments, the processing system 66 also includes a central processing unit (CPU) 69 and memory 70 for performing functions such as executing software to perform tasks. The processing system 66 also includes a digital data interface 72 for receiving and sending messages from and to ground control, a CODEC 74 for converting digital audio data from the CPU 69 to analog audio data for the cockpit audio system and for converting analog audio data from the cockpit audio system to digital audio data for the CPU 69, and a USB port 76 for downloading data and/or software such as digital audio data or CPDLC message sets, or voice recognition software. Once downloaded, the digital data is stored in the memory 70. The processing system 66 also includes a display interface 78 for generating the graphical displays presented on the display 24 (FIGS. 2A-4B). In addition, the processing system 66 includes a button interface 80 for converting the displacement of any of the buttons 26-36 (FIGS. 2A-4B) into digital data for the CPU 69. And, the processing system 66 includes a knob encoder 82 including a conventional 2-bit digital quadrature interface for converting the rotational and axial displacement of the knob 42 (FIGS. 2A-4B) into digital data for the CPU 69.

Still referring to FIG. 5, in this and certain other embodiments, the audio enunciator circuit 67 can play out a string of digital audio data when prompted by the CPU 69. Furthermore, a string of digital audio data can correspond to a message received or sent or a request generated or any other desired event encountered by the module's processing system 66. Consequently, the memory 70 typically stores many digital audio data strings. The digital audio data can include prerecorded entire messages or words to be assembled into messages or portions of words (phonemes) to be assembled by a speech synthesizer into messages that correspond to the text of a message or instruction for the processing system 66 such as “confirm” or “send”. Additionally or alternatively the digital audio data can include a sound, such as a tone or chime.

The CPU 69 prompts the enunciator circuit 67 to retrieve and play a string of digital audio data according to the event encountered by the processing system 66. For example, when the processing system 66 receives a message, the CPU 69 determines whether a digital audio data string is associated with the event of receiving the message. If so, then the CPU 69 instructs the enunciator circuit 67 to retrieve the digital audio data string and play it. Then the CPU 69 determines whether a digital audio data string is associated with the text of the message received. If so, then the CPU 69 instructs the enunciator circuit 67 to retrieve the digital audio data string and play it. In another example, the CPU 69 performs the same operations when the pilot or other user selects a response to an uplink message. In this example, when the digital audio data is played out, the pilot or other user hears a request to confirm the selected response. In another example, the CPU 69 can perform the same operations when the pilot or other user sends a message. In this example, the enunciator circuit 67 can play a digital audio data string that produces a sound to indicate the message was sent.

Still referring to FIG. 5, in this and certain other embodiments, the processing system 66 also includes audio circuitry 84 connectable to the cockpit audio system for aurally providing analog audio data to the pilot and other persons on the cockpit audio system and patching an aural checklist provided by an aural checklist system (not shown) into the cockpit audio system. The audio circuitry 84 can include a stereo headphone output amplifier 86 to drive typical headphone sets as low as 32 ohms of impedance. The circuitry 84 also can include a stereo line out amplifier 88 to match the stereo output to suitable line levels for connecting the aural checklist system into auxiliary inputs of the cockpit audio system. The circuitry 84 also can include a line in amplifier 90 to place the audio portion of the checklist system in-line with the cockpit audio final mixed output or suitably patch the audio portion of the checklist system to any other auxiliary audio input/output ports in the cockpit audio system. In addition, the audio circuitry 84 can include a microphone preamp 92 so that voice audio data may be sampled by the system 66 for use by the speech recognition component 68.

Still referring to FIG. 5, in this and certain other embodiments, the speech recognition component 68 identifies a command spoken by the pilot or other user and instructs the processing system 66 to perform one or more tasks associated with the command. To help the speech recognition component 68 quickly identify a spoken command, the speech recognition component 68 identifies possible commands with an operational state of the module in which the command is likely to be spoken. For example, the speech recognition component 68 can identify the command “confirm” with the module's state after a pilot or other user has selected a message to send. Furthermore, the speech recognition component can notify the pilot or other user when it does recognize a spoken command or when it does not. For example, when a command is spoken and the speech recognition component 68 recognizes the command, the enunciator circuit 67 can play a string of digital audio data that generates a sound indicating recognition. And, when a spoken command is not recognized, the enunciator circuit 67 can play a different string of digital audio data.

Still referring to FIG. 5, in this and certain other embodiments, the processing system 66 can include a checklist of tasks that corresponds to an uplink message and a possible response to the uplink message and is stored in the memory 70 of the system 66. The checklist is associated with an uplink message by a tag included in the message. After the processing system 66 receives an uplink message that is associated with a checklist and the pilot confirms a response to the uplink message that requires the pilot to perform tasks from a checklist, the module can automatically display a portion of the checklist. Thus, the pilot or other user does not have to locate and obtain a checklist from another computer system or location in the cockpit. Once a portion of the checklist is displayed, the module can scroll through and display other portions of the checklist as the pilot accomplishes the tasks displayed. In addition, the module can also aurally provide the pilot the checklist through the cockpit audio system by enunciating the tasks included in the checklist.

Although the CPDLC module has been described in considerable detail with reference to certain embodiments for purposes of illustration, other embodiments are possible, therefore the spirit and scope of the appended claims should not be limited to the above description of the embodiments; the present inventions include suitable modifications as well as all permutations and combinations of the subject matter set forth herein.

What is claimed is:

1. An aircraft controller-pilot data link communications module comprising:
a multi-line display that visually presents a list of CPDLC messages which can be scrolled to display any portion of the list of messages, wherein the list of messages can be scrolled from a top of the display to a bottom of the display such that the most recent message presented is located at the top of the display or scrolled from the bottom of the display to the top of the display such that the most recent message presented is located at the bottom of the display.

2. The module of claim 1 wherein one or more of the displayed messages include an indicator that indicates whether the message was an uplink message or a downlink message.

3. The module of claim 1 wherein the display presents a direction arrow that indicates scrolling direction of the list of uplink and downlink messages.

4. An aircraft controller-pilot data link communications module comprising a display that visually presents a list of uplink messages wherein a displayed uplink message includes a response tag that identifies a selected response to the uplink message.

5. The module of claim 4 wherein the tag comprises a letter of the alphabet corresponding to the selected response.

6. The module of claim 4 wherein the tag is included in the displayed uplink message if and only if the selected response was sent by the module.

7. An aircraft controller-pilot data link communications module comprising a display that, when an uplink message is received, displays identifiers for one or more possible responses appropriate to the uplink message and does not display identifiers of other possible responses appropriate to other possible uplink messages.

8. The module of claim 7 wherein the module also enunciates one or more aural identifiers of the one or more possible responses appropriate to the uplink message.

9. An aircraft controller-pilot data link communications module for handling CPDLC messages, comprising:
a memory containing a plurality of digital audio data strings; and
a digital audio enunciator circuit that plays out a string of digital audio data from the memory corresponding to a CPDLC message selected from a plurality CPDLC messages.

10. The module of claim 9 wherein the digital audio data strings include digital audio voice data.

11. The module of claim 9 wherein the module plays out the corresponding audio data when the module receives a CPDLC message.

12. The module of claim 9 wherein the module plays out the corresponding audio data when the module transmits a CPDLC message.

13. The module of claim 9 wherein a string of digital audio data corresponds to a request to confirm a response to an uplink message, and wherein the module plays out said string of audio data before the module transmits the response.

14. The module of claim 11 wherein the play out of audio data can be selectively turned on or off.

15. The module of claim 10 wherein the digital audio voice data is synthesized.

16. The module of claim 10 wherein the digital audio voice data is pre-recorded.

17. The module of claim 9 wherein an aural sound sounds when the module receives an uplink message and a different aural sound sounds to confirm transmission of a response before the module transmits the response.

18. An aircraft controller-pilot data link communications module for handling CPDLC messages, comprising:
an audio input that receives spoken audio voice data; and
a speech recognition component that identifies commands in the spoken audio voice data.

19. The module of claim 18 wherein the speech recognition component uses an identifier of a current state of the module to facilitate identifying a spoken command.

20. The module of claim 19 wherein a first aural sound sounds when the speech recognition component identifies a command in the audio voice data that is included in a set of possible commands associated with the identifier of a current state of the module, and a second aural sound sounds when the speech recognition component identifies a command in the audio voice data that is not included in the set of possible commands associated with the identifier of a current state.

21. An aircraft controller-pilot data link communications module comprising:
a memory storing a checklist corresponding to an uplink message and a possible response to the uplink message; and
a display that, when a user confirms the possible response to the uplink message, automatically displays the checklist.

22. The module of claim 21 wherein the module enunciates the checklist aurally.

23. The module of claim 21 wherein the displayed checklist can be scrolled to present any portion of the checklist.

24. The module of claim 21 wherein the uplink message is distinguished from other uplink messages that are not associated with a checklist by a tag that is received with the uplink message.

25. An aircraft controller-pilot data link communications module comprising:
one or more programmable buttons to input data into the module and a display that visually presents a label corresponding to each programmable button, wherein the label indicates the function of the corresponding programmable button;
for a given button, two or more functions can be performed by the button and the function that will be performed if the button is pressed at a particular time is indicated by the label associated with the button at that time; and
wherein CPDLC messages can be displayed and selected and, when a CPDLC message is selected, the one or more programmable buttons are automatically programmed to receive input that is appropriate to the content of the selected message and the labels automatically and correspondingly change to indicate the function of the corresponding programmable button.

26. An aircraft controller-pilot data link communications module comprising:
a display that visually presents a list of possible CPDLC response messages to an uplink message; and
a knob operable by a user to confirm selection of a possible response.

27. The module of claim 26 wherein the knob can be pushed for less than a predetermined duration to advance by one message through the list of possible response messages to select a possible message and that can be pushed for the predetermined duration or longer to confirm selection of a possible response message.

28. The module of claim 27 wherein, if the module has received a plurality of uplink messages, a first press of the knob for less than the pre-determined duration causes the display to present the most recent uplink message and possible response messages to the uplink message.

29. The module of claim 27 wherein the predetermined duration is adjustable.

30. The module of claim 26 wherein the knob can be rotated to scroll through a list of received uplink messages.

31. The module of claim 26 wherein the knob can be rotated to scroll through a list of possible data values to be input to the module.

32. A method in a controller-pilot data link communications module for selecting and confirming a response to an uplink message, comprising:
receiving an uplink message requiring a response;
visually presenting one or more possible responses appropriate to the content of the uplink message;
receiving from a user a selection of a response from the one or more possible responses presented; and
receiving from a user a confirmation of the selected response before issuing the response.

33. The method of claim 32 wherein the confirmation of the selected response is received when a knob is pushed for a predetermined duration or longer.

34. The method of claim 33 wherein, when the knob is pushed for less than the predetermined duration, the selection advances from one possible response to another.
